(19) United States
(12) Patent Application Publication
(10) Pub. No.: US 2023/0202507 A1
(43) Pub. Date: Jun. 29, 2023

(54) CONTROL SYSTEM FOR AUTONOMOUS VEHICLE SIMULATOR

(71) Applicant: GM Cruise Holdings LLC, San Francisco, CA (US)

(72) Inventor: Jacqueline Chu, Danville, CA (US)

(21) Appl. No.: 17/558,748

(22) Filed: Dec. 22, 2021

(51) Int. Cl. B60W 60/00; G06N 20/00; G06V 20/58

(52) U.S. Cl. CPC B60W 60/001; G06N 20/00; G06V 20/58; B60W 2420/42; B60W 2420/52; B60W 2554/4049

(57) ABSTRACT

Systems, methods, and computer-readable media are disclosed for a control system for an autonomous vehicle (AV) simulator. A disclosed method comprises receiving configuration information for simulating a virtual environment of a three-dimensional (3D) scene; generating a plurality of simulation configurations for simulating the virtual environment based on a parameter specified in the configuration information; for each simulation configuration of the plurality of simulation configurations, simulating the virtual environment within an AV simulator using a virtual sensor based on the simulation configuration; evaluating the simulations of the virtual environment using a machine learning (ML) model for navigating an autonomous vehicle; comparing data recorded during the evaluation of the simulations using the ML model to drive data recorded in a physical environment by a vehicle having a first sensor; and generating a report associated with the virtual sensor based on a comparison of the data.

### DESCRIPTION OF THE RELATED TECHNOLOGY

Autonomous vehicles are vehicles having computers and control systems that perform driving and navigation tasks that are conventionally performed by a human driver. As autonomous vehicle technologies continue to advance, ride-sharing services will increasingly utilize autonomous vehicles to improve service efficiency and safety. However, autonomous vehicles will be required to perform many of the functions that are conventionally performed by human drivers, such as avoiding dangerous or difficult routes, and performing other navigation and routing tasks necessary to provide safe and efficient transportation. Such tasks may require the collection and processing of large quantities of data disposed on the autonomous vehicle.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of a system for managing one or more Autonomous Vehicles (AVs) in accordance with some aspects of the present technology;

FIG. 2 illustrates an example diagram of a Continuous Learning Machine (CLM) for resolving uncommon scenarios in an AV according to an example of the instant disclosure;

FIG. 3 illustrates an example lifecycle of a machine learning (ML) model according to an example of the instant disclosure;

FIG. 4 illustrates a control system for AV simulations according to an example of the instant disclosure;

FIG. 5 illustrates an example method for controlling parameters of an AV simulator in accordance with some examples;

FIG. 6 illustrates another example method for controlling parameters of an AV simulator in accordance with some examples; and

FIG. 7 shows an example of a system for implementing certain aspects of the present technology.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Systems, methods, and computer-readable media are disclosed for a control system to control an autonomous vehicle (AV) simulator for simulating an autonomous vehicle in a three-dimensional (3D) virtual environment. In some examples, a control system is configured to control sensor, object, and simulator parameters in an AV simulator at runtime and evaluate the results of the AV simulations. This provides feedback and allows an operator (e.g., a user, an integrated test, etc.) to identify how the machine learning (ML) model operates based on different parameters to converge performance differences in the simulated performance and measured performance. This improves simulation accuracy and increases the effectiveness of simulations, can be used to create uncommon scenarios to train and evaluate ML models for an AV.

In some examples, a method for controlling an AV simulator is disclosed. The method comprises receiving configuration information for simulating a virtual environment of a 3D scene, generating a plurality of simulation configurations for simulating the virtual environment based on a parameter specified in the configuration information, for each simulation configuration of the plurality of simulation configurations, simulating the virtual environment using a virtual sensor based on the simulation configuration, evaluating the simulations of the virtual environment using an ML model for navigating an autonomous vehicle, comparing data recorded during the evaluation of the simulations using the ML model to drive data recorded in a physical environment by a vehicle having a first sensor corresponding to the virtual sensor, and generating a report associated with the virtual sensor based on a comparison of the data recorded during the evaluation to the drive data. In some examples, the disclosed systems, methods, and computer-readable media provide a control system for improving AV simulations to reduce the differences in measured performance (e.g., in the physical world) and simulated performance (e.g., in the virtual world), and improve training and evaluation of the various ML models.

### Example Embodiments

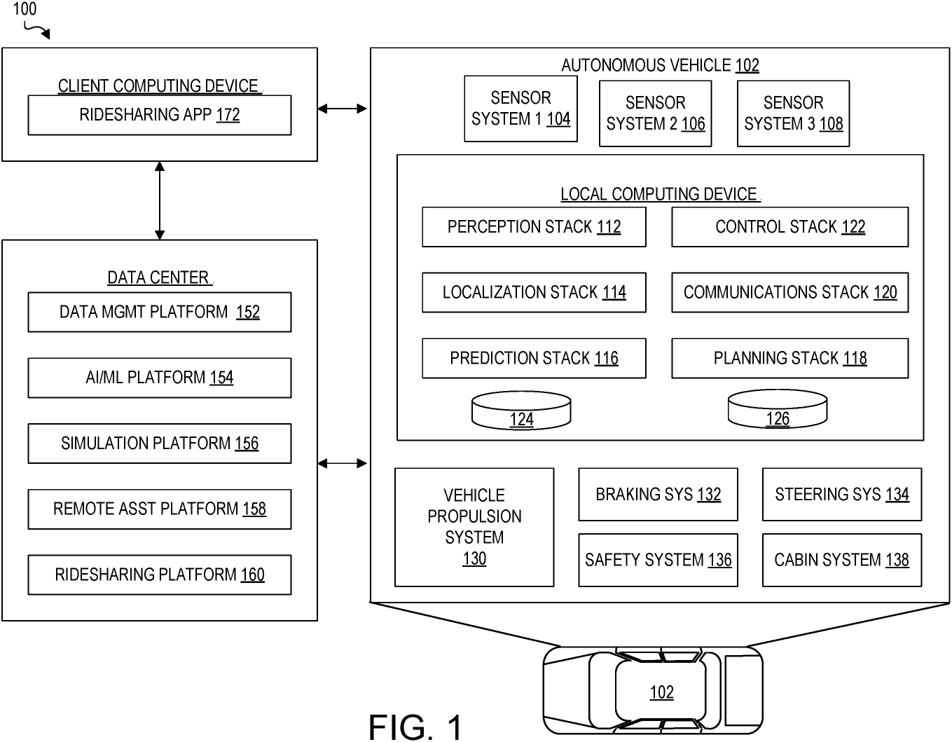

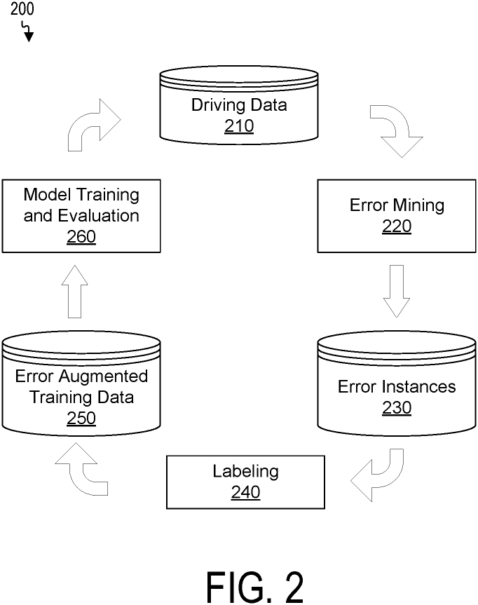

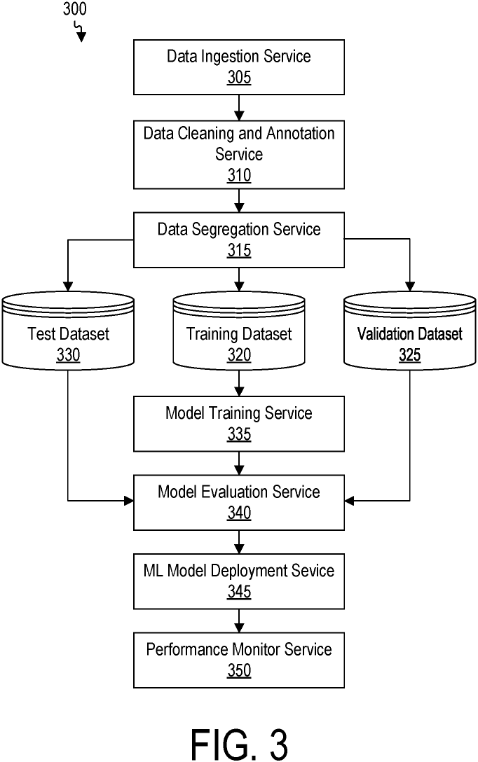

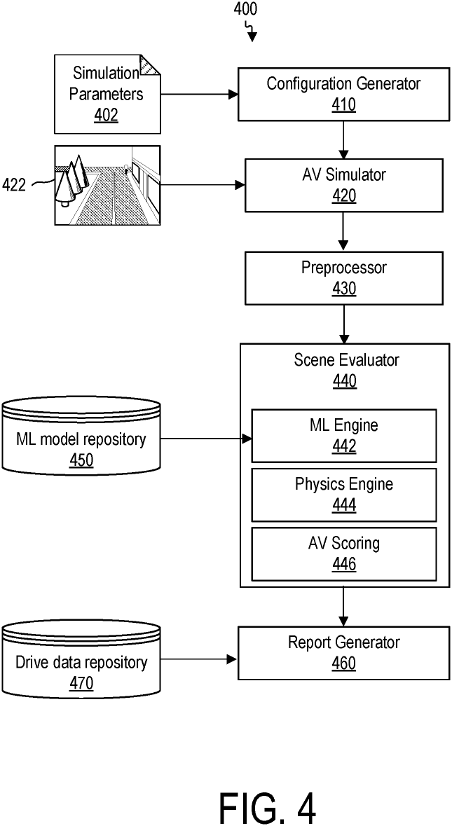

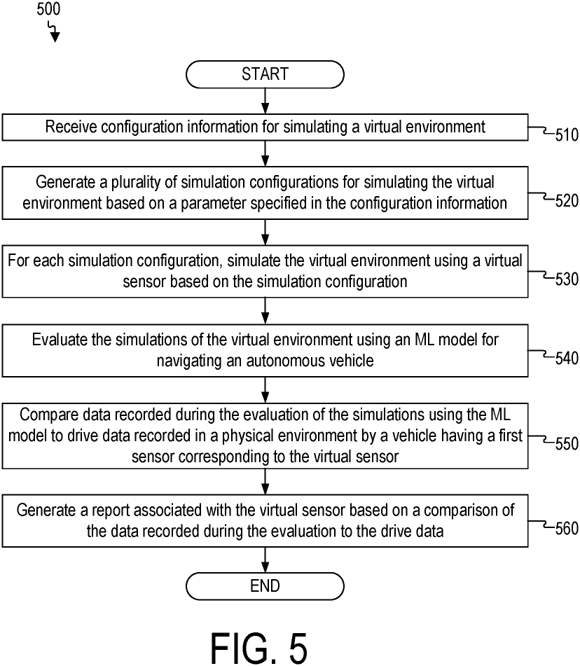

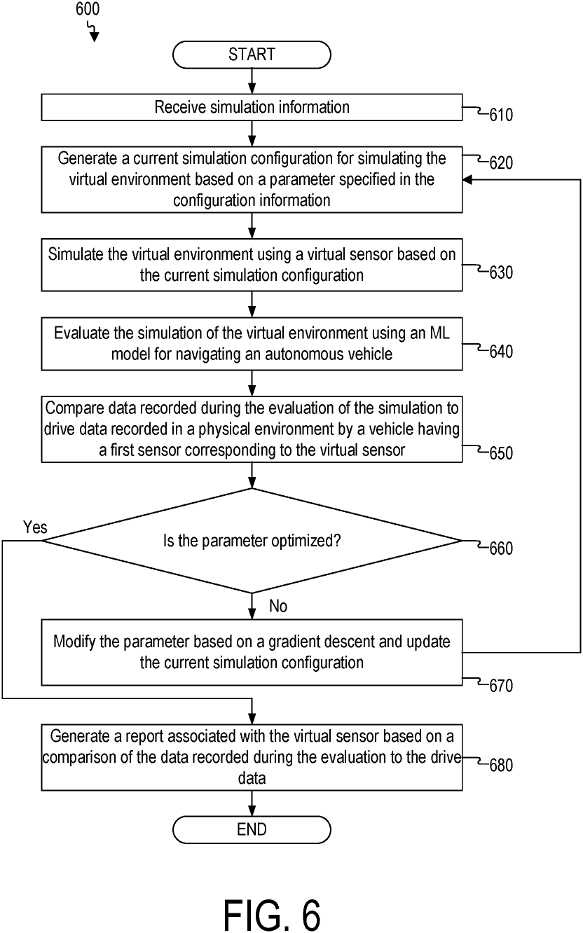

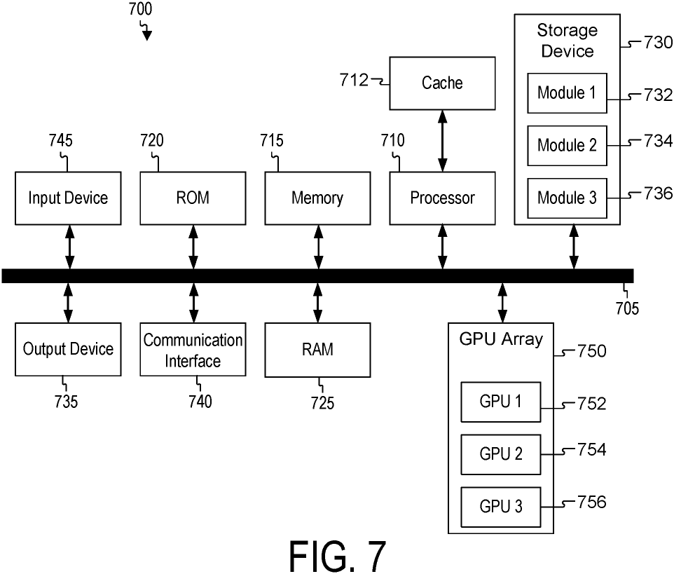

A description of an AV management system and a continual learning machine (CLM) for the AV management system, as illustrated in FIGS. 1 and 2, are first disclosed herein. An overview of a neural network lifecycle is disclosed in FIG. 3. A control system for tuning parameters of an AV simulator is disclosed in FIG. 4 and is followed by methods performed by the control system in FIGS. 5 and 6. The discussion then concludes with a brief description of example devices, as illustrated in FIG. 7. These variations shall be described herein as the various embodiments are set forth. The disclosure now turns to FIG. 1.

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light detection and ranging (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV’s environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and a high definition (HD) geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV’s position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV’s steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104 –108, stacks 112 – 122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or another system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general-purpose computing device for accessing the ridesharing application 172. The client computing device 170 can be a customer’s mobile computing device or a computing device integrated with the AV 102 (e.g., the local computing device 110). The ridesharing platform 160 can receive requests to pick up or drop off from the ridesharing application 172 and dispatch the AV 102 for the trip.

FIG. 2 illustrates an example diagram of a CLM 200 that solves long-tail prediction problem in an AV in accordance with some examples. The CLM 200 is a continual loop that iterates and improves based on continual feedback to learn and resolve driving situations experienced by the AV.

The CLM 200 begins with a fleet of AVs that are outfitted with sensors to record a real-world driving scene. In some cases, the fleet of AVs is situated in a suitable environment that represents challenging and diverse situations such as an urban environment to provide more learning opportunities. The AVs record the driving situations into a collection of driving data 210.

The CLM 200 includes an error mining 220 to mine for errors and uses active learning to automatically identify error cases and scenarios having a significant difference between prediction and reality, which are added to a dataset of error instances 230. The error instances are long-tail scenarios that are uncommon and provide rich examples for simulation and training. The error instances 230 store high-value data and prevents storing datasets with situations that are easily resolved.

The CLM 200 also implements a labeling function 240 that includes both automated and manual data annotation of data that is stored in error augmented training data 250 and used for future predictions. The automated data annotation is performed by an ML labeling annotator that uses a neural network trained to identify and label error scenarios in the datasets. Using the ML labeling annotator enables significant scale, cost, and speed improvements that allow the CLM 200 to cover mores scenario of the long tail. The labeling function 240 also includes functionality to allow a human annotator to supplement the ML labeling function. By having both an automated ML labeling function and a manual (human) labeling annotator, the CLM 200 can be populated with dense and accurate datasets for prediction.

The final step of the CLM 200 is model training and evaluation 260. A new model (e.g., a neural network) is trained based on the error augmented training data 250 and the new model is tested extensively using various techniques to ensure that the new model exceeds the performance of the previous model and generalizes well to the nearly infinite variety of scenarios found in the various datasets. The model can also be simulated in a virtual environment and analyzed for performance. Once the new model has been accurately tested, the new model can be deployed in an AV to record driving data 210. The CLM 200 is a continual feedback loop that provides continued growth and learning to provide accurate models for an AV to implement.

In practice, the CLM can handle many uncommon scenarios, but the AV will occasionally need to account for new and infrequent scenarios that would be obvious to a human. For example, an AV may encounter another motorist making an abrupt and sometimes illegal U-turn. The U-turn can be at a busy intersection or could be mid-block, but the U-turn will be a sparse data point as compared to more common behaviors such as moving straight, left turns, right turns, and lane changes. Applying our CLM principles, an initial deployment model may not optimally predict U-turn situations and error situations commonly include U-turns. As the dataset grows and more error scenarios of U-turns are identified, the model can be trained to sufficiently predict a U-turn and allow the AV to accurately navigate this scenario.

The CLM 200 can be applied to any number of scenarios that a human will intuitively recognize including, for example, a K-turn (or a 3-point turn), lane obstructions, construction, pedestrians, animated objects, animals, emergency vehicles, funeral processions, jaywalking, and so forth. The CLM 200 provides a mechanism for continued learning to account for diverse scenarios that are present in the physical world.

FIG. 3 illustrates an example lifecycle 300 of an ML model in accordance with some examples. The first stage of the lifecycle 300 of an ML model is a data ingestion service 305 to generate datasets described below. ML models require a significant amount of data for the various processes described in FIG. 3 and the data persisted without undertaking any transformation to have an immutable record of the original dataset. The data itself can be generated by sensors attached to an AV, for example, but can also be provided from third-party sources such as publicly available dedicated datasets used for research purposes. The data ingestion service 305 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data (e.g., an AV) from the consumer of the data (e.g., an ML model training pipeline). For offline data production, when source data is available from the producer (e.g., the AV), the producer publishes a message and the data ingestion service 305 retrieves the data. In some examples, the data ingestion service 305 may be online and the data is streamed from the producer (e.g., the AV) in real-time for storage in the data ingestion service 305.

After data ingestion service 305, a data preprocessing service preprocesses the data to prepare the data for use in the lifecycle 300 and includes at least data cleaning, data transformation, and data selection operations. The data preprocessing service 310 removes irrelevant data (data cleaning) and general preprocessing to transform the data into a usable form. In some examples, the data preprocessing service 310 may convert 3D LIDAR data (e.g., 3D point cloud data) into voxels. The data preprocessing service 310 includes labeling of features relevant to the ML model such as people, vegetation, vehicles, and structural objects in the case of an AV. In some examples, the data preprocessing service 310 may be a semi-supervised process performed by an ML to clean and annotate data that is complemented with manual operations such as labeling of error scenarios, identification of untrained features, etc.

After the data preprocessing service 310, data segregation service 315 separates data into at least a training dataset 320, a validation dataset 325, and a test dataset 330. Each of the training dataset 320, a validation dataset 325, and a test dataset 330 are distinct and do not include any common data to ensure that evaluation of the ML model is isolated from the training of the ML model.

The training dataset 320 is provided to a model training service 335 that uses a supervisor to perform the training, or the initial fitting of parameters (e.g., weights of connections between neurons in artificial neural networks) of the ML model. The model training service 335 trains the ML model based on a gradient descent or stochastic gradient descent to fit the ML model based on an input vector (or scalar) and a corresponding output vector (or scalar).

After training, the ML model is evaluated at a model evaluation service 340 using data from the validation dataset 325 and different evaluators to tune the hyperparameters of the ML model. The predictive performance of the ML model is evaluated based on predictions on the validation dataset 325 and iteratively tunes the hyperparameters based on the different evaluators until the best fit for the ML model is identified. After the best fit is identified, the test dataset 330, or holdout data set, is used as a final check to perform an unbiased measurement on the performance of the final ML model by the model evaluation service 340. In some cases, the final dataset that is used for the final unbiased measurement can be referred to as the validation dataset and the dataset used for hyperparameter tuning can be referred to as the test dataset.

After the ML model has been evaluated by the model evaluation service 340, an ML model deployment service 345 can deploy the ML model into an application or a suitable device. The deployment can be into a further test environment such as a simulation environment, or into another controlled environment to further test the ML model. In the case of an AV, the ML model can undergo further evaluation inside a simulated environment and, after further validation, can be deployed in the AV. In some examples, the ML model can be implemented as part of the perception stack 112 to detect objects.

After deployment by the ML model deployment service 345, a performance monitor service 350 monitors for the performance of the ML model. In some cases, the performance monitor service 350 can also record performance data such as driving data that can be ingested via the data ingestion service 305 to provide further data, additional scenarios, and further enhance the training of ML models.

FIG. 4 illustrates a control system 400 for AV simulations according to an example of the instant disclosure. In some examples, the control system 400 is configured to generate a plurality of simulations to converge measured performance with simulated performance. In some cases, sensor performance in is different than measured performance in the physical environment. Some aspects of the physical environment are difficult to model in the virtual environment or precise modeling cannot be achieved due to complexity. For example, vegetation (e.g., trees, bushes) and atmospheric effects (e.g., steam, fog, etc.) are difficult to model because of complex geometry and complex physical properties. The control system 400 is configured to identify parameters associated with various aspects of the simulation to converge the difference in simulated performance in the virtual environment and measured performance in the physical environment (e.g., data recorded by an AV).

Initially, a user prepares a set of simulation parameters 402 to evaluate in the control system 400. The simulation parameters 402 include a variety of parameters to change during the various simulations. For example, the parameters can be related to a scene, various aspects of the simulation such as an ML model, a branch in a version control system (e.g., Git, Subversion, etc.) associated with the ML model, a parameter associated with the simulation, etc. The simulation parameters can be provided via a schema-less input such as JavaScript object notation (JSON), a schema-oriented input such as yet another markup language (YAML) or extensible markup language (XML). The parameters can identify fixed or dynamic values. The fixed values are static and will not change, but dynamic values will be changed at runtime of the control system 400. An example YAML parameter is illustrated below.

| | |
|---|---|
| sim_sweep: | |
| sensor_materials: | # Attributes to change |
| CruisePhysicalMaterial: | # Change class property |
| IntensityValue: | # Name of property |
| start: 25 | # inclusive |
| end: 28 | # inclusive |
| step: 1 | # Step of size one |

In the YAML configuration, the YAML configures changes to the properties of the CruisePhysicalMaterial class and changes the Intensity Value. In this example, the sweep starts at 25 and ends at 28 with a step size of one (e.g., 25, 26, 27, 28), configuring four different iterations. An example JSON configured can correspond to the YAML configuration and identifies types (e.g., string, integer, and/or floats) that can be associated with the parameters.

{
// A list of parameters for applicable for both content and code changes
“sim_sweep”:
[
{
“parameter name”: <string>,
“asset_dir”: <string>, // optional, required if a content change
// optional, required if a content change; unix style
“file_regex”: <string>,
“sweep”:
{
“start”: < integer | float > // inclusive
“end”: < integer | float > // inclusive
// Required when the value type is a number
“step”: < integer | float >
}
},
...
]
}

The simulation parameters 402 can include parameters associated with one or more sensors used by the simulator. For example, in the case simulating based on a LIDAR sensor, the parameters can include a LIDAR intensity, a wavelength of the LIDAR, LIDAR noise parameters, etc. In other examples, in the case of simulating based on image sensors, the parameters can include intrinsic and extrinsic camera parameters such as depth, focal length, lens distortion, etc. The simulation parameters 402 can also include parameters associated with the simulated environment such as material properties, lighting parameters, and configurations, etc.

The simulation parameters 402 are input into a configuration generator 410 and create a plurality of simulation configurations. For example, in the YAML example of performing a parameter sweep, four simulation configurations would be created. The simulation configurations are input into an AV simulator 420 which receives a 3D scene 422 to simulate and perform each simulation of the 3D scene based on the configuration.

In some examples, the 3D scene 422 can be static to reduce the complexity and reduce iteration to allow complex parameter sweeps to be configured. In other examples, the 3D scene can be dynamic and can perform a test of the sensor as it moves in the 3D environment. In some other examples, the 3D scene can include an ML model to determine how to navigate the 3D environment (e.g., an ML model associated with traversing a road with respect to traffic and other obstructions).

The AV simulator 420 is configured to record data based on the sensor to be used in conjunction with an ML model associated with that sensor. For example, if the simulation is configured with an image sensor, the AV simulator 420 produces two-dimensional (2D) bitmap images that can be input into an ML model for analyzing the images. In the example of a LIDAR sensor, the AV simulator 420 produces 3D point cloud data that identify distances to various objects in the scene.

The output of the AV simulator 420 may not necessarily be directly compatible with the ML model and may need to be preprocessed by preprocessor 430. For example, 3D point cloud data may be massive while the ML model for LIDAR may have a limited compute budget and, to allow simplify the calculation within the compute budget, the input for the ML model is converted into a different format, such as voxels, that reduces computing complexity. Accordingly, the preprocessor 430 converts the output of the AV simulator 420 into a format suitable for the corresponding ML model.

The processed output of the preprocessor 430 is provided into a scene evaluator 440. The scene evaluator 440 is configured to analyze the processed output of the preprocessor 430 based on one or more evaluation backends. Example backends can include but are not limited to, an ML engine 442 that uses an input ML model, a physics engine 444 and performs physics-based simulations, and an AV scoring 446.

In the case of the scene evaluator 440 using the ML engine 442, the ML engine 442 is configured to receive an ML model from an ML model repository 450 and evaluate the performance of the processed output in the corresponding ML model. For example, the output of the preprocessor 430 is streamed into the ML model to correspond to a real-time simulation to simulate the performance of the ML model. In some examples, the ML model is configured to detect objects in the simulated scene and the scene evaluator 440 receives the decisions by the ML model. For example, the simulation by the AV simulator 420 can provide simulated data that corresponds to the sensor, and the ML model can receive the data (after preprocessing by the preprocessor 430) and identify various objects in the 3D scene 422 such as vegetation, pedestrians, cars, etc.

The scene evaluator 440 records data from the backend and provides the data to a report generator 460 in connection with building a report related to the simulation. The report generator 460 is configured to receive drive data from a drive data repository 470. The drive data repository 470 is a database, application, or another type of tooling that allows the control system 400 to receive drive data. In some examples, the drive data at least partially corresponds to an object on the 3D scene 422. By correlating the 3D scene 422 with drive data from the physical world, various parameters of the AV simulator 420 can be tuned to identify parameters that converge simulated performance with measured performance.

In some examples, the report generator 460 can be configured to omit the comparison to drive data (which can also be referred to as road data). The report generator 460 in that case identifies optimum values of the parameters and generates a report associated with the parameters and their result. In some cases, there may be multiple candidate parameters, and the report can facilitate a user’s consumption and understanding of how the different parameters affect the sensor. A user can consume the report and identify parameters for further simulations (e.g., training of an ML model, evaluation of an ML model, etc.) based on the control system 400.

The control system 400 provides a semi-supervised pipeline to identify simulation parameters of the AV simulator 420 to converge simulated performance and measured performance. The accuracy of the simulations is important because uncommon scenarios can be implemented in simulations, and the uncommon scenarios can be used to train or evaluate ML models. This converges any differences between simulated performance and measured performance to increase the accuracy of the simulation with respect to the drive data. Improving the simulation accuracy facilitates ML model training and evaluation, which improves the accuracy of the various ML models. In this example, the simulations are not dependent on previous results and therefore can be parallelized in a cloud-based system to reduce the simulation time.

In other examples, the control system 400 may be configured to perform a different type of iteration to tune different parameters to reduce the number of iterations. For example, the control system 400 may be configured to use gradient descent operations to tune and optimize the simulation parameters 402.

FIG. 5 illustrates an example method 500 for tuning parameters of an AV simulator in accordance with some examples. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence. In some examples, the method 500 may be configured to execute in a single computer system (e.g., the computing system 700) or in a distributed data center having many computing systems 700 that distribute operations associated with the method 500.

According to some examples, the method includes receiving configuration information for simulating a virtual environment of a 3D scene at block 510. For example, the computing system 700 illustrated in FIG. 7 may receive configuration information for simulating a virtual environment of a 3D scene.

According to some examples, the method includes generating (e.g., by the computing system 700) a plurality of simulation configurations for simulating the virtual environment based on a parameter specified in the configuration information at block 520.

In some examples, the parameter is based on a type of sensor and various properties of that sensor. For example, the sensor could be a LIDAR sensor and corresponding parameters include LIDAR intensity, noise, wavelength, etc. In other examples, the sensor could be a radar sensor and corresponding parameters include atmospheric permittivity, wavelength, frequency, signal characteristics, etc. In some other examples, the sensor could be an imaging sensor and corresponding parameters include focal length, depth, distortion, etc.

In other examples, the parameter may be associated with the simulator parameter that affects the various aspects of the system. For example, a simulation parameter may be related to reflections associated with a particular class of materials (e.g., such as absorption, reflection, refraction, etc.). In the case of a parameter sweep, the parameter can include a start value (e.g., 0), an end value (e.g., 255), and an interval (e.g., 8).

In some example, the parameter may be associated with objects in the virtual environment, and the object may include two sub-objects that are modeled differently and have different parameters. For example, vegetation can have largely rigid portions that are dense and reflective (e.g., a tree trunk) while also including more sparse portions that are less dense. For example, foliage of a tree may be modeled to have a low reflective value while its trunk and some branches may have a larger reflective value. Modeling the foliage with high reflective value significantly increases the 3D point cloud distribution and corresponding calculations, while modeling the foliage with a low reflective value reduces the 3D point cloud complexity.

According to some examples, the method 500 includes, for each simulation configuration of the plurality of simulation configurations, simulating (e.g., by the computing system 700) the virtual environment using a virtual sensor based on the simulation configuration at block 530.

According to some examples, the method 500 includes evaluating (e.g., by the computing system 700) the simulations of the virtual environment using an ML model for navigating an autonomous vehicle at block 540. In some examples, the evaluation can be performed based on a selected backend engine (e.g., ML engine, physics engine, etc.).

According to some examples, the method 500 includes comparing data recorded during the evaluation of the simulations using the ML model to drive data recorded in a physical environment by a vehicle having a first sensor at block 550. In some example, the drive data can at least partially correspond to the virtual environment (e.g., have at least one similar object of interest). In another example of block 550, the method comprises comparing (e.g., by the computing system 700) data recorded during the evaluation of the simulations using the physics engine to other data for inclusion in the report. In some examples, the drive data can be omitted in the comparison and the various simulation data can be compared to identify optimum parameters.

According to some examples, the method 500 includes generating a report associated with the virtual sensor based on a comparison of the data to the drive data at block 560. The report identifies parameters that allow a user to determine optimum characteristics. In some cases, the report can identify a maximum value for a single parameter. However, in the case of multiple parameters that are tuned, a person may use the report to identify tradeoffs and select optimum parameters. In some cases, the parameters can be stored in a repository associated with the various integrated pipelines to allow the parameters to be integrated into other systems to improve simulation, ML training, and ML evaluation.

FIG. 6 illustrates another example method 600 for tuning parameters of an AV simulator in accordance with some examples. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method 600 includes receiving (e.g., by the computing system 700) configuration information for simulating a virtual environment of a 3D scene at block 610. The simulation configuration can identify at least one parameter of the simulation to tune. For example, the parameter can be associated with the simulator or a sensor used by the simulator. The method 600 may then generate (e.g., by the computing system 700) a current simulation configuration for simulating the virtual environment based on a parameter specified in the configuration information at block 620.

At block 630, the method 600 may simulate the virtual environment using a virtual sensor based on the current simulation configuration. The output of the simulation is the sensor data that an ML may use in an AV. At block 640, the method 600 may evaluate the simulation of the virtual environment using an ML model. In some examples, the ML model can be configured into an AV as part of the various stacks (e.g., perception stack 112) and perform functions such as object detection, object classification, etc.

The method 600 can compare data recorded during the evaluation of the simulation to drive data recorded in a physical environment by a vehicle having a first sensor corresponding to the virtual sensor at block 650.

After evaluating the simulation, the method 600 may compare data recorded during the evaluation of the simulation to drive data recorded in a physical environment by a vehicle having a first sensor corresponding to the virtual sensor at block 650. The method 600 may then determine if the parameter has been optimized at block 660. If the parameter is not optimized, the method 600 may then modify the parameter based on a gradient descent and update the current simulation configuration at block 670. After modifying the current simulation configuration, the method returns to block 620 to perform another iteration. If the parameter is optimized at block 660, the method 600 generates a report associated with the virtual sensor based on a comparison of the data recorded during the evaluation to the drive data at block 680. The report may identify at least one optimized value of the parameter.

FIG. 7 shows an example of computing system 700, which can be for example any computing device making up the control system 400 or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 710 and connection 705 that couples various system components including system memory 715, such as read-only memory (ROM) 720 and random access memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, RAMs, ROM, and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

The computing system 700 can also include a graphical processing unit (GPU) array 750 or any similar processor for performing massively complex and parallel mathematical operations such as simulations, games, neural network training, and so forth. The GPU array 750 includes at least one GPU and is illustrated to have three GPUs comprising GPU 752, GPU 754, and GPU 756. However, the GPU array 750 can be any number of GPUs. In some examples, the GPU core can be integrated into a die of the processor 710.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method, comprising: receiving configuration information for simulating a virtual environment of a 3D scene; generating a plurality of simulation configurations for simulating the virtual environment based on a parameter specified in the configuration information; for each simulation configuration of the plurality of simulation configurations, simulating the virtual environment within an AV simulator using a virtual sensor based on the simulation configuration; evaluating the simulations of the virtual environment using a ML model for navigating an autonomous vehicle; comparing data recorded during the evaluation of the simulations using the ML model to drive data recorded in a physical environment by a vehicle having a first sensor corresponding to the virtual sensor; and generating a report associated with the virtual sensor based on a comparison of the data recorded during the evaluation to the drive data.

Aspect 2. The method of Aspect 1, wherein the parameter is associated with the virtual sensor and includes a start value, and an end value, and an interval.

Aspect 3. The method of any of Aspects 1 to 2, wherein the first sensor comprises a LIDAR sensor, and wherein the parameter comprises at least one of a LIDAR intensity.

Aspect 4. The method of any of Aspects 1 to 3, wherein the first sensor comprises a camera, and wherein the parameter comprises at least one of a depth, field of vision, a focal length, or an aperture.

Aspect 5. The method of any of Aspects 1 to 4, wherein the parameter relates to an intrinsic parameter of the AV simulator.

Aspect 6. The method of any of Aspects 1 to 5, wherein the parameter is associated with an object in the virtual environment and includes a start value, and an end value, and an interval.

Aspect 7. The method of any of Aspects 1 to 6, wherein the parameter corresponds to a material property associated with an object in the virtual environment.

Aspect 8. The method of any of Aspects 1 to 7, wherein the parameter is associated with a first characteristic of a first region of the object, and wherein the configuration information includes a second parameter associated with the first characteristic of a second region of the object.

Aspect 9. The method of any of Aspects 1 to 8, wherein the parameter corresponds to an atmospheric effect or a volumetric effect to apply to the virtual environment.

Aspect 10. The method of any of Aspects 1 to 9, further comprising: evaluating the simulations of the virtual environment using a physics engine; comparing data recorded during the evaluation of the simulations using the physics engine to other data for inclusion in the report.

Aspect 11: A system includes a storage (implemented in circuitry) configured to store instructions and a processor. The processor configured to execute the instructions and cause the processor to: receive configuration information for simulating a virtual environment of a 3D scene; generate a plurality of simulation configurations for simulating the virtual environment based on a parameter specified in the configuration information; for each simulation configuration of the plurality of simulation configurations , simulate the virtual environment within an AV simulator using a virtual sensor based on the simulation configuration; evaluate the simulations of the virtual environment using a ML model for navigating an autonomous vehicle; compare data recorded during the evaluation of the simulations using the ML model to drive data recorded in a physical environment by a vehicle having a first sensor corresponding to the virtual sensor; and generate a report associated with the virtual sensor based on a comparison of the data recorded during the evaluation to the drive data.

Aspect 12: The system of Aspect 11, wherein the parameter is associated with the virtual sensor and includes a start value, and an end value, and an interval.

Aspect 13: The system of any of Aspects 11 to 12, wherein the first sensor comprises a LIDAR sensor, and wherein the parameter comprises at least one of a LIDAR intensity.

Aspect 14: The system of any of Aspects 11 to 13, wherein the first sensor comprises a camera, and wherein the parameter comprises at least one of a depth, field of vision, a focal length, or an aperture.

Aspect 15: The system of any of Aspects 11 to 14, wherein the parameter relates to an intrinsic parameter of the AV simulator.

Aspect 16: The system of any of Aspects 11 to 15, wherein the parameter is associated with an object in the virtual environment and includes a start value, and an end value, and an interval.

Aspect 17: The system of any of Aspects 11 to 16, wherein the parameter corresponds to a material property associated with an object in the virtual environment.

Aspect 18: The system of any of Aspects 11 to 17, wherein the parameter is associated with a first characteristic of a first region of the object, and wherein the configuration information includes a second parameter associated with the first characteristic of a second region of the object.

Aspect 19: The system of any of Aspects 11 to 18, wherein the parameter corresponds to an atmospheric effect or a volumetric effect to apply to the virtual environment.

Aspect 20: The system of any of Aspects 11 to 19, wherein the processor is configured to execute the instructions and cause the processor to: evaluate the simulations of the virtual environment using a physics engine; compare data recorded during the evaluation of the simulations using the physics engine to other data for inclusion in the report.

Aspect 21: A computer readable medium comprising instructions using a computer system. The computer includes a memory (e.g., implemented in circuitry) and a processor (or multiple processors) coupled to the memory. The processor (or processors) is configured to execute the computer readable medium and cause the processor to: receive configuration information for simulating a virtual environment of a 3D scene; generate a plurality of simulation configurations for simulating the virtual environment based on a parameter specified in the configuration information; for each simulation configuration of the plurality of simulation configurations, simulate the virtual environment within an AV simulator using a virtual sensor based on the simulation configuration; evaluate the simulations of the virtual environment using a ML model for navigating an autonomous vehicle; compare data recorded during the evaluation of the simulations using the ML model to drive data recorded in a physical environment by a vehicle having a first sensor corresponding to the virtual sensor; and generate a report associated with the virtual sensor based on a comparison of the data recorded during the evaluation to the drive data.

Aspect 22: The computer readable medium of Aspect 21, wherein the parameter is associated with the virtual sensor and includes a start value, and an end value, and an interval.

Aspect 23: The computer readable medium of any of Aspects 21 to 22, wherein the first sensor comprises a LIDAR sensor, and wherein the parameter comprises at least one of a LIDAR intensity.

Aspect 24: The computer readable medium of any of Aspects 21 to 23, wherein the first sensor comprises a camera, and wherein the parameter comprises at least one of a depth, field of vision, a focal length, or an aperture.

Aspect 25: The computer readable medium of any of Aspects 21 to 24, wherein the parameter relates to an intrinsic parameter of the AV simulator.

Aspect 26: The computer readable medium of any of Aspects 21 to 25, wherein the parameter is associated with an object in the virtual environment and includes a start value, and an end value, and an interval.

Aspect 27: The computer readable medium of any of Aspects 21 to 26, wherein the parameter corresponds to a material property associated with an object in the virtual environment.

Aspect 28: The computer readable medium of any of Aspects 21 to 27, wherein the parameter is associated with a first characteristic of a first region of the object, and wherein the configuration information includes a second parameter associated with the first characteristic of a second region of the object.

Aspect 29: The computer readable medium of any of Aspects 21 to 28, wherein the parameter corresponds to an atmospheric effect or a volumetric effect to apply to the virtual environment.

Aspect 30: The computer readable medium of any of Aspects 21 to 29, wherein the processor is configured to execute the computer readable medium and cause the processor to: evaluate the simulations of the virtual environment using a physics engine; compare data recorded during the evaluation of the simulations using the physics engine to other data for inclusion in the report.

1. A method, comprising:
receiving configuration information for simulating a virtual environment of a three-dimensional (3D) scene;
generating a plurality of simulation configurations for simulating the virtual environment based on a parameter specified in the configuration information;
for each simulation configuration of the plurality of simulation configurations, simulating the virtual environment within an AV-autonomous vehicle (AV)simulator using a virtual sensor based on the simulation configuration;
evaluating the simulations of the virtual environment using a machine learning (ML) model for navigating an AV;
comparing data recorded during the evaluation of the simulations using the ML model to drive data recorded in a physical environment by a vehicle having a first sensor corresponding to the virtual sensor; and
generating a report associated with the virtual sensor based on a comparison of the data recorded during the evaluation to the drive data.

2. The method of claim 1, wherein the parameter is associated with the virtual sensor and includes a start value, and an end value, and an interval.

3. The method of claim 2, wherein the first sensor comprises a light detection and ranging (LIDAR) sensor, and wherein the parameter comprises at least one of a LIDAR intensity.

4. The method of claim 2, wherein the first sensor comprises a camera, and wherein the parameter comprises at least one of a depth, field of vision, a focal length, or an aperture.

5. The method of claim 1, wherein the parameter relates to an intrinsic parameter of the AV simulator.

6. The method of claim 1, wherein the parameter is associated with an object in the virtual environment and includes a start value, and an end value, and an interval.

7. The method of claim 6, wherein the parameter corresponds to a material property associated with an object in the virtual environment.

8. The method of claim 7, wherein the parameter is associated with a first characteristic of a first region of the object, and wherein the configuration information includes a second parameter associated with the first characteristic of a second region of the object.

9. The method of claim 1, wherein the parameter corresponds to an atmospheric effect or a volumetric effect to apply to the virtual environment.

10. The method of claim 1, further comprising:
evaluating the simulations of the virtual environment using a physics engine;
comparing data recorded during the evaluation of the simulations using the physics engine to other data for inclusion in the report.

11. A system comprising:
a storage configured to store instructions;
a processor configured to execute the instructions and cause the processor to:
receive configuration information for simulating a virtual environment of a three-dimensional (3D) scene;
generate a plurality of simulation configurations for simulating the virtual environment based on a parameter specified in the configuration information;
for each simulation configuration of the plurality of simulation configurations , simulate the virtual environment within an autonomous vehicle (AV)simulator using a virtual sensor based on the simulation configuration;
evaluate the simulations of the virtual environment using a machine learning (ML) model for navigating an AV;
compare data recorded during the evaluation of the simulations using the ML model to drive data recorded in a physical environment by a vehicle having a first sensor corresponding to the virtual sensor; and
generate a report associated with the virtual sensor based on a comparison of the data recorded during the evaluation to the drive data.

12. The system of claim 11, wherein the parameter is associated with the virtual sensor and includes a start value, and an end value, and an interval.

13. The system of claim 12, wherein the first sensor comprises a light detection and ranging (LIDAR) sensor, and wherein the parameter comprises at least one of a LIDAR intensity.

14. The system of claim 12, wherein the first sensor comprises a camera, and wherein the parameter comprises at least one of a depth, field of vision, a focal length, or an aperture.

15. The system of claim 11, wherein the parameter relates to an intrinsic parameter of the AV simulator.

16. The system of claim 11, wherein the parameter is associated with an object in the virtual environment and includes a start value, and an end value, and an interval.

17. The system of claim 16, wherein the parameter corresponds to a material property associated with an object in the virtual environment.

18. The system of claim 17, wherein the parameter is associated with a first characteristic of a first region of the object, and wherein the configuration information includes a second parameter associated with the first characteristic of a second region of the object.

19. The system of claim 11, wherein the parameter corresponds to an atmospheric effect or a volumetric effect to apply to the virtual environment.

20. A non-transitory computer readable medium comprising instructions, the instructions, when executed by a computing system, cause the computing system to:
receive configuration information for simulating a virtual environment of a three-dimensional (3D) scene;
generate a plurality of simulation configurations for simulating the virtual environment based on a parameter specified in the configuration information;
for each simulation configuration of the plurality of simulation configurations , simulate the virtual environment within an autonomous vehicle (AV)simulator using a virtual sensor based on the simulation configuration;
evaluate the simulations of the virtual environment using a machine learning (ML) model for navigating an AV;
compare data recorded during the evaluation of the simulations using the ML model to drive data recorded in a physical environment by a vehicle having a first sensor corresponding to the virtual sensor; and
generate a report associated with the virtual sensor based on a comparison of the data recorded during the evaluation to the drive data.
